(19) United States
(12) Patent Application Publication
(10) Pub. No.: US 2022/0284499 A1
(43) Pub. Date: Sep. 8, 2022

(54) FEATURE-LEVEL RECOMMENDATIONS FOR CONTENT ITEMS

(71) Applicant: Viralspace, LLC, San Francisco, CA (US)

(72) Inventors: Apoorva Dornadula, San Francisco, CA (US); Michelle Xi Lu, San Francisco, CA (US); Kai Ping Tien, San Francisco, CA (US); Palash Rakesh Shastri, Sunnyvale, CA (US)

(21) Appl. No.: 17/680,764

(22) Filed: Feb. 25, 2022

Related U.S. Application Data
(60) Provisional application No. 63/155,409, filed on Mar. 2, 2021.

(51) Int. Cl. G06Q 30/06

(52) U.S. Cl. CPC G06Q 30/0631

(57) ABSTRACT

Techniques are provided for generating feature-level recommendations for content items. One method comprises obtaining feature values related to a content item; applying the feature values to a trained engagement prediction model that generates an influence score for each feature value, wherein the influence score for each feature value indicates an influence of each respective feature value on a performance indicator associated with the content item; generating a recommendation for improving the performance indicator using the influence score for each feature value; and initiating a modification of the content item using the recommendation. Features can be selected using an artificial intelligence technique that performs a sub-image analysis on historical content items to evaluate an area of influence for a region of the historical content items when a feature value of a feature is changed. An automated feature extraction process may extract feature values using machine learning model.

### CROSS-REFERENCE TO RELATED APPLICATION(S)

The present application claims priority to U.S. Provisional Patent Application Ser. No. 63/155,409, filed Mar. 2, 2021, entitled “Systems and Methods for Generating High Performing Advertisements Through the Use of Multi-Modal and Explainable Visual Intelligence,” incorporated by reference herein in its entirety.

### FIELD

The field relates generally to information processing techniques, and more particularly, to techniques for evaluating content items.

### BACKGROUND

Digital content is increasingly delivered through a range of digital channels. It is often difficult to identify one or more characteristics of such digital content that can be modified to increase a likelihood that consumers of such digital content will engage with, and/or react favorably to, such digital content.

A need exists for improved techniques for generating suggestions for changes to such digital content.

### SUMMARY

In one embodiment, a method comprises obtaining a plurality of feature values related to a content item, wherein each given one of the plurality of feature values corresponds to a respective one of a plurality of features; applying the plurality of feature values to at least one trained engagement prediction model that generates an influence score for each of the plurality of feature values, wherein the influence score for each of the plurality of feature values indicates an influence of each respective feature value on at least one performance indicator associated with the content item; generating one or more recommendations for improving the at least one performance indicator associated with the content item using the influence score for each of the plurality of feature values; and initiating at least one modification of the content item using at least one of the one or more recommendations.

In some embodiments, one or more of the plurality of corresponding features are selected using an artificial intelligence technique that performs a sub-image analysis on at least one historical content item, and wherein the sub-image analysis comprises evaluating an area of influence for at least one region of the at least one historical content item when a feature value of at least one feature associated with the at least one region is changed. One or more of the plurality of feature values may be determined using an automated feature extraction process that employs at least one machine learning model and wherein at least some of the automatically determined feature values are modified using a manual process. The at least one machine learning model may be updated based at least in part on at least some of the automatically determined feature values that are modified using the manual process.

In one or more embodiments, the generating the one or more recommendations for improving the at least one performance indicator associated with the content item may further comprise selecting a given corresponding feature having a feature value with an influence score in a predefined range and modifying the feature value of the given corresponding feature to a new value having an improved influence score in a different predefined range. The generating the one or more recommendations for improving the at least one performance indicator associated with the content item may further comprise assigning a given content item to at least one cluster of a plurality of clusters of content items and wherein the given content item inherits at least one recommendation based at least in part on one or more properties of the at least one cluster. The generating the one or more recommendations for improving the at least one performance indicator associated with the content item may further comprise selecting a new feature value for a given feature if a change of a performance indicator for the new feature value relative to the performance indicator for a current feature value for the given feature satisfies one or more performance criteria.

Other illustrative embodiments include, without limitation, systems and processor-readable storage media comprising program code.

### BRIEF DESCRIPTION OF THE DRAWINGS

FIG. 1 illustrates an information processing environment in accordance with an exemplary embodiment of the disclosure;

FIG. 2 is a flow diagram illustrating an exemplary implementation of a feature-level recommendations process for content items, according to an embodiment of the disclosure;

FIG. 3 is a block diagram illustrating an exemplary feature-level recommendation system that generates one or more feature-level recommendations for a new content item, according to one embodiment of the disclosure;

FIG. 4 is a block diagram illustrating an exemplary feature selection system that selects one or more features to be processed by the trained engagement prediction model of FIG. 3, according to one illustrative embodiment of the disclosure;

FIG. 5 is a block diagram illustrating an exemplary feature extraction system that extracts one or more features from content items, according to an illustrative embodiment;

FIG. 6 is a block diagram illustrating an exemplary feature-level influence scoring system that generates one or more influence scores for one or more feature vectors associated with one or more corresponding new content items, according to at least one embodiment of the disclosure;

FIG. 7A is a graph illustrating a number of exemplary influence scores assigned to particular feature values of a given content item using the feature-level influence scoring system of FIG. 6, according to one embodiment of the disclosure;

FIG. 7B illustrates a number of exemplary content item modification recommendations for the given content item of FIG. 7A based on the exemplary influence scores assigned to particular feature values of the given content item in the example of FIG. 7A, according to an embodiment;

FIG. 8A illustrates an exemplary automated clustering process that applies a hash function to feature vectors of historical content items to group the feature vectors into clusters, according to at least one embodiment of the disclosure;

FIG. 8B is a block diagram illustrating an exemplary cluster-based feature-level recommendation engine that generates one or more content item recommendations for a new content item, according to at least one embodiment of the disclosure;

FIG. 9 illustrates an exemplary ranking system that ranks one or more content item recommendations generated for a new content item, according to at least one embodiment of the disclosure;

FIG. 10 illustrates an exemplary processing device that may implement one or more portions of at least one embodiment of the disclosure; and

FIG. 11 illustrates an exemplary cloud-based processing platform in which cloud-based infrastructure and/or cloud-based services can be used to generate feature-level recommendations for content items, according to an exemplary embodiment.

### DETAILED DESCRIPTION

Illustrative embodiments of the present disclosure will be described herein with reference to exemplary processing devices. The disclosure is not restricted to the particular illustrative configurations described herein, as would be apparent to a person of ordinary skill in the art. One or more embodiments of the disclosure provide methods, apparatus and processor-readable storage media for generating feature-level recommendations for content items.

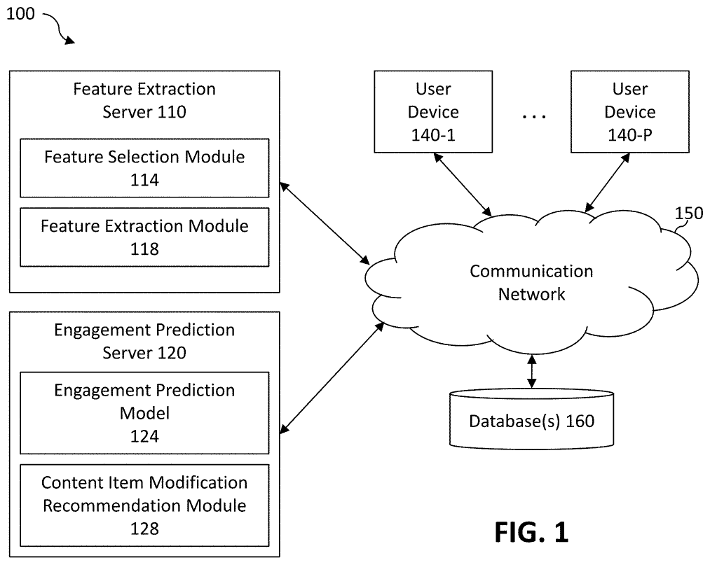

FIG. 1 illustrates an information processing environment 100 in accordance with an exemplary embodiment of the disclosure. The information processing environment 100 comprises a feature extraction server 110, an engagement prediction server 120, one or more user devices 140-1 through 140-P and one or more databases 160. The user devices 140 may comprise, for example, computing devices, such as computers, mobile phones or tablets. The term “user” as used herein shall be broadly interpreted so as to encompass, for example, human, hardware, software or firmware entities, and/or various combinations of such entities.

In the example of FIG. 1, the feature extraction server 110, the engagement prediction server 120 and user devices 140 are coupled to a communication network 150 (e.g., a portion of a larger computer network, such as the Internet, a telephone network, a cable network, a cellular network, a wide area network, a local area network, or various combinations of at least portions of such networks.

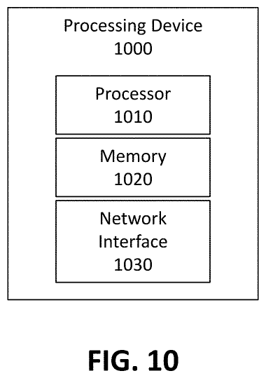

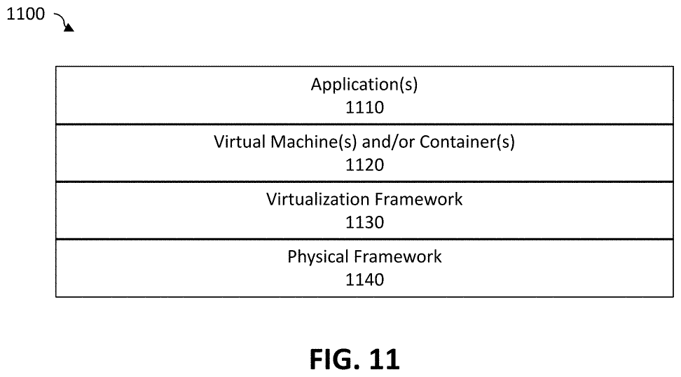

One or more of the feature extraction server 110, the engagement prediction server 120 and the user devices 140 comprise processing devices each having a processor and a memory that may employ virtualized infrastructure, as discussed further below in conjunction with FIGS. 10 and 11. Such processing devices can illustratively include particular arrangements of compute, storage and network resources (each potentially employing virtualized infrastructure). The processor may comprise, for example, a microprocessor, a microcontroller, a central processing unit (CPU), an application-specific integrated circuit (ASIC), a field-programmable gate array (FPGA) and/or other processing circuitry. The memory may comprise a random access memory (RAM), a read-only memory (ROM) and/or other types of processor-readable storage media storing executable program code or other software programs.

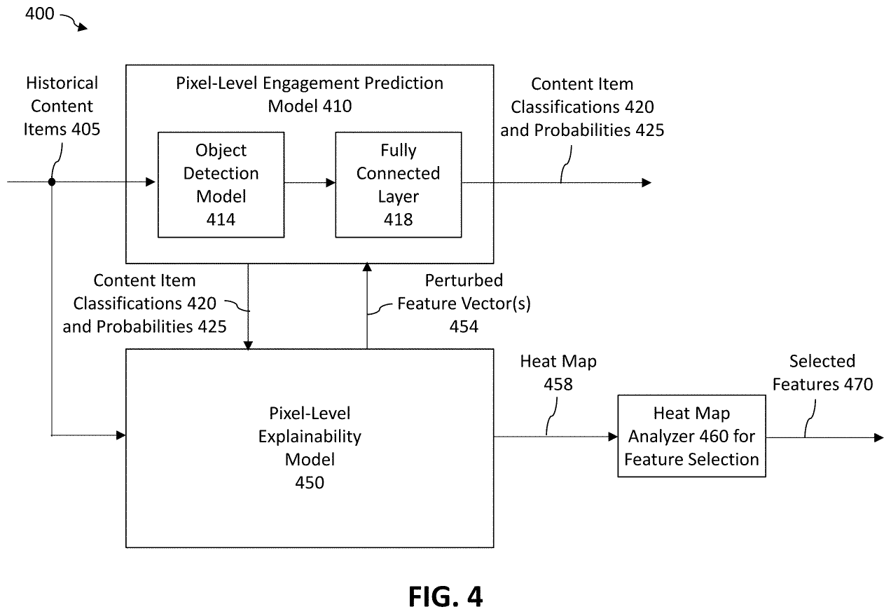

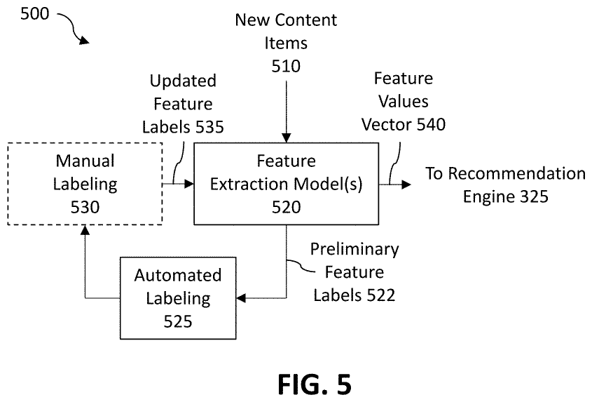

In the example of FIG. 1, the exemplary feature extraction server 110 comprises a feature selection module 114 and a feature extraction module 118. The term module as used herein denotes any combination of software, hardware, and/or firmware that can be configured to provide the corresponding functionality of the module. In one or more embodiments, the feature selection module 114 may perform one or more processing tasks on at least some historical content items to select one or more features for further processing by the engagement prediction server 120, as discussed further below in conjunction with FIG. 4. The feature extraction module 118 processes one or more new content items to extract one or more features selected by the feature selection module 114, as discussed further below in conjunction with FIG. 5. Modules 114, 118, or portions thereof, may be implemented at least in part in the form of software that is stored in memory and executed by a processor. The feature extraction server 110 may include one or more additional modules or other components (not shown in FIG. 1) typically found in conventional implementations of such server devices. For example, one or more different processing devices and/or memory components may be employed to implement different ones of modules 114, 118, or portions thereof.

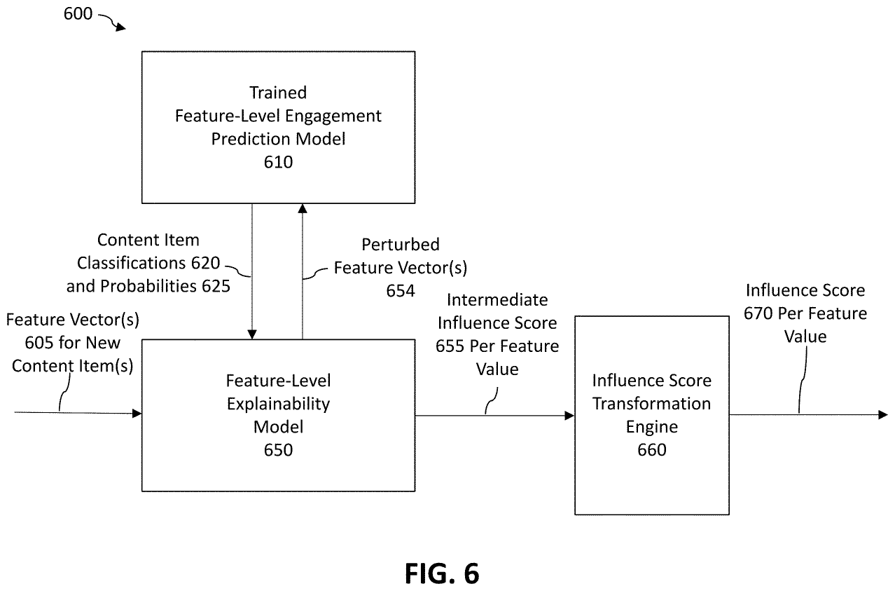

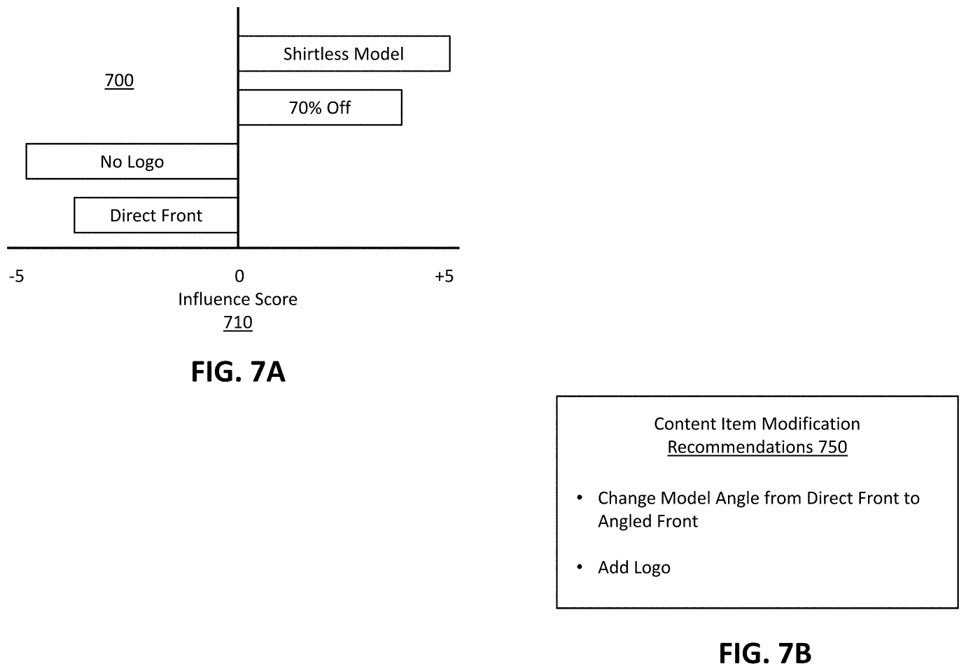

As shown in FIG. 1, the exemplary engagement prediction server 120 comprises an engagement prediction model 124 and a content item modification recommendation module 128. The engagement prediction model 124 may comprise one or more trained engagement prediction models to assign an influence score to one or more new content items, as discussed further below in conjunction with FIG. 6. The content item modification recommendation module 128 processes the influence scores generated by the engagement prediction model 124 to generate one or more recommended modifications for one or more content items, as discussed further below in conjunction with FIGS. 7A and 7B. Model 124 and/or module 128, or portions thereof, may be implemented at least in part in the form of software that is stored in memory and executed by a processor. The engagement prediction server 120 may include one or more additional modules or other components (not shown in FIG. 1) typically found in conventional implementations of such server devices. For example, one or more different processing devices and/or memory components may be employed to implement different ones of elements 124, 128, or portions thereof.

The arrangement of modules 114, 118 illustrated in the feature extraction server 110 and/or elements 124, 128 illustrated in the engagement prediction server 120 of FIG. 1 are presented for illustration, and alternative implementations may be used in other embodiments. For example, the functionality provided by (i) modules 114 and/or 118 of the feature extraction server 110 and/or (ii) elements 124 and/or 128 of the engagement prediction server 120, in other embodiments, may be combined into one module, or separated across multiple modules.

In the example of FIG. 1, the feature extraction server 110 and/or the engagement prediction server 120 can have one or more associated databases 160 configured to store information related, for example, to content items (such as an identifier, one or more marketing channels and one or more creative components associated with each content item), features associated with each content item, and recommendations and an influence score associated with each content item. While such information is stored in a single database 160 in the example of FIG. 1, an additional or alternative instance of the database 160, or portions thereof, may be employed in other embodiments.

The feature extraction server 110, the engagement prediction server 120 and/or the user devices 140 may comprise one or more associated input/output devices (not shown), which illustratively comprise keyboards, displays or other types of input/output devices in any combination. Such input/output devices can be used, for example, to support one or more user interfaces to a user device 140, as well as to support communication between the engagement prediction server 120 and/or other related systems and devices not explicitly shown.

The particular arrangement of elements shown in FIG. 1 for generating feature-level recommendations for content items is presented by way of example only, and additional or alternative elements may be used in other embodiments.

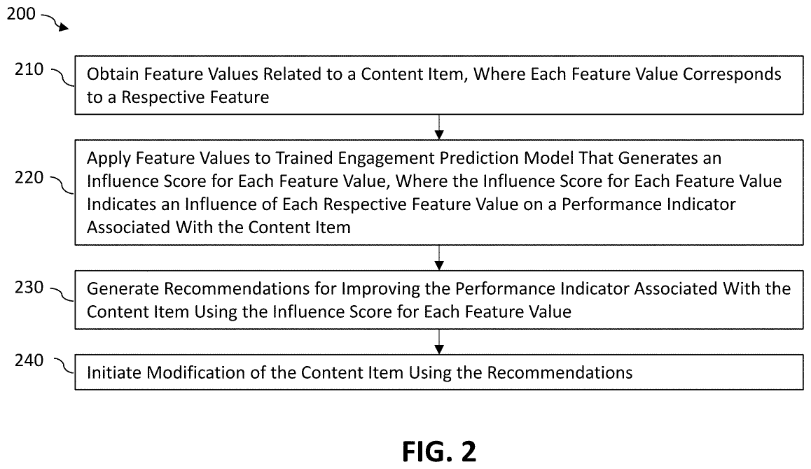

FIG. 2 is a flow diagram illustrating an exemplary implementation of a feature-level recommendations process 200 for content items, according to an embodiment of the disclosure. In the example of FIG. 2, the feature-level recommendations process 200 initially obtains feature values related to a content item in step 210, where each feature value corresponds to a respective feature. In step 220, the feature values are applied to a trained engagement prediction model that generates an influence score for each feature value, where the influence score for each feature value indicates an influence of each respective feature value on a performance indicator associated with the content item. The content item may comprise at least one component of a larger content item. The content item may be, for example, a text file, a video file or an image file, or combinations thereof, that represent advertisements or other marketing materials.

One or more recommendations are generated in step 230 for improving the performance indicator associated with the content item using the influence score for each feature value. Finally, in step 240, a modification of the content item is initiated using at least one of the one or more recommendations.

In some embodiments of the feature-level recommendations process 200, at least some of the features may be selected using an artificial intelligence technique that performs a sub-image analysis on at least one historical content item, and the sub-image analysis may comprise evaluating an area of influence for at least one region of the at least one historical content item when a feature value of at least one feature associated with the at least one region is changed, as discussed further below in conjunction with FIG. 4. In addition, at least some of the feature values may be determined using an automated feature extraction process that employs at least one machine learning model and at least some of the automatically determined feature values may be modified using a manual process. For example, the at least one machine learning model may be updated based on at least some of the automatically determined feature values that are modified using the manual process.

In one or more embodiments, a plurality of the trained engagement prediction models is employed and a given one of the plurality of trained engagement prediction models is selected for the content item based on a performance of each of the plurality of trained engagement prediction models. The trained engagement prediction model may determine a SHapley Additive exPlanations (SHAP) value for each of the feature values that indicates an impact of a given feature on a performance of the content item.

The generating of the one or more recommendations for improving the at least one performance indicator associated with the content item may further comprise selecting a given corresponding feature having a feature value with an influence score in a predefined range (e.g., having a negative influence score) and modifying the feature value of the given corresponding feature to a new value having an improved influence score in a different predefined range (e.g., having a positive influence score).

A given corresponding feature may have multiple different feature values and wherein at least one of the multiple different feature values can be selected for the given corresponding feature by ranking at least some of the multiple different feature values using a predicted performance value for each of the multiple different feature values.

In some embodiments, the generating the one or more recommendations for improving the at least one performance indicator associated with the content item may comprise assigning a given content item to at least one cluster of a plurality of clusters of content items and wherein the given content item inherits at least one recommendation based at least in part on one or more properties of the at least one cluster. A threshold may be determined for the at least one performance indicator by evaluating an average performance indicator value for each of the plurality of feature values for each of a plurality of clusters of content items. In addition, the generating the one or more recommendations for improving the at least one performance indicator associated with the content item may further comprise selecting a new feature value for a given feature if a change of a performance indicator for the new feature value relative to the performance indicator for a current feature value for the given feature satisfies one or more performance criteria.

In one or more embodiments, the influence score of at least a first one of a plurality of feature values associated with a given feature may be assigned based on at least one influence score assigned to at least one additional feature value that is correlated with the first feature value. For example, consider a feature value “object:sun” that may directly correspond with the feature value “background:bright”. The phenomenon where multiple features are correlated is called multi-collinearity. The performance of some machine learning algorithms may be impaired in the presence of multi-collinearity among features. Tree-based models, however, generally do not suffer from this issue, as they tend to use uncorrelated features to achieve a given model task. Such tree-based models may ignore many features, causing the SHAP values for such features to be zero (causing the influence score for many features to also be zero).

The one or more recommendations for improving the at least one performance indicator associated with the content item may comprise a plurality of recommendations and the plurality of recommendations can be aggregated based on a consensus between a plurality of different recommendation methods that generated the plurality of recommendations. In addition, one or more of a ranking and a weight associated with the plurality of different recommendation methods may be updated based on implicit feedback derived from one or more user actions with respect to at least one of the one or more recommendations (e.g., whether a given recommendation was adopted, implemented, saved or ignored). In some embodiments, a weight associated with one or more of the features may be modified based on a performance of at least one of the one or more recommendations.

The particular processing operations and other functionality described in conjunction with FIG. 2 are presented by way of example, and should not be considered as limiting the scope of the disclosure. For example, additional operations can be performed. Different arrangements can use other types and orders of operations to generate feature-level recommendations for content items. For example, the ordering of the operations may be changed in other embodiments, or one or more operations may be performed in parallel with one or more other operations.

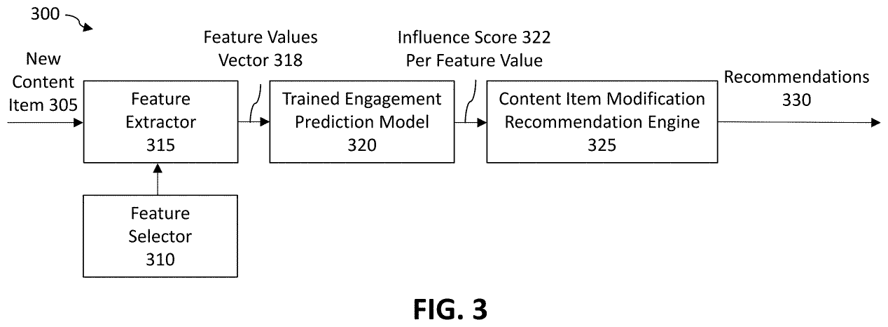

FIG. 3 is a block diagram illustrating an exemplary feature-level recommendation system 300 that generates one or more feature-level recommendations for a new content item 305, according to one embodiment of the disclosure. In the example of FIG. 3, the feature-level recommendation system 300 comprises a feature extractor 315, discussed further below in conjunction with FIG. 5, that processes the new content item 305 and generates a feature values vector 318 comprising a feature value for each feature selected by a feature selector 310, as discussed further below in conjunction with FIG. 4. The feature values vector 318 may optionally comprise one or more temporal feature values to provide time awareness in some embodiments.

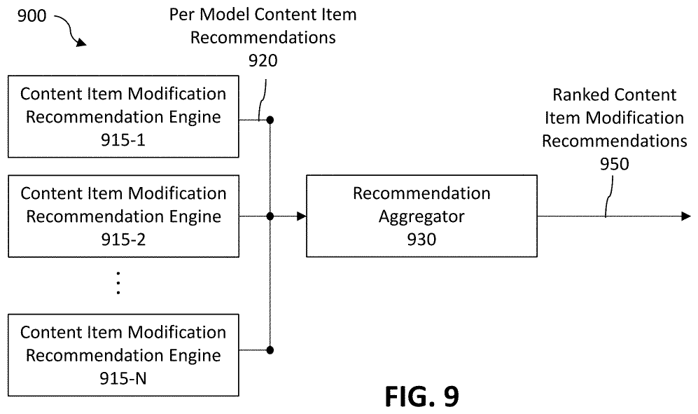

The feature values vector 318 is processed by a trained engagement prediction model 320 that generates an influence score 322 for each feature value in the feature values vector 318, as discussed further below in conjunction with the example of FIG. 6. As noted above, the influence score for each feature value may indicate an influence of each respective feature value on a performance indicator associated with the content item (e.g., how influential a certain feature value is when predicting the performance of a content item). For example, in some embodiments, a negative influence score for a given feature value may indicate that when the given feature value is included in a given content item, the predicted performance of the given content item corresponds to a lower number (e.g., a lower predicted engagement). In addition, a positive influence score for a given feature value may indicate that when the given feature is included in the given content item, the predicted performance of the given content item corresponds to a higher number (e.g., a higher predicted engagement). One or more content item modification recommendation engines 325, discussed further below in conjunction with FIG. 9, evaluate the influence score 322 for each feature value and generate one or more recommendations 330 for the new content item 305.

In one or more embodiments, one or more different methods are employed by the exemplary content item modification recommendation engines 325 to generate the recommendations 330. According to at least one exemplary recommendation method, influence scores are used to impact which features should be recommended to change. For example, say that the feature value “cat”, “dog”, and “koala” (for an exemplary feature category: objects) have the influence scores, −1, 0, and 1, respectively. This recommendation method would ignore “dog” and “koala” since it has a non-negative influence score and would instead generate a recommendation to change the feature value for “cat”.

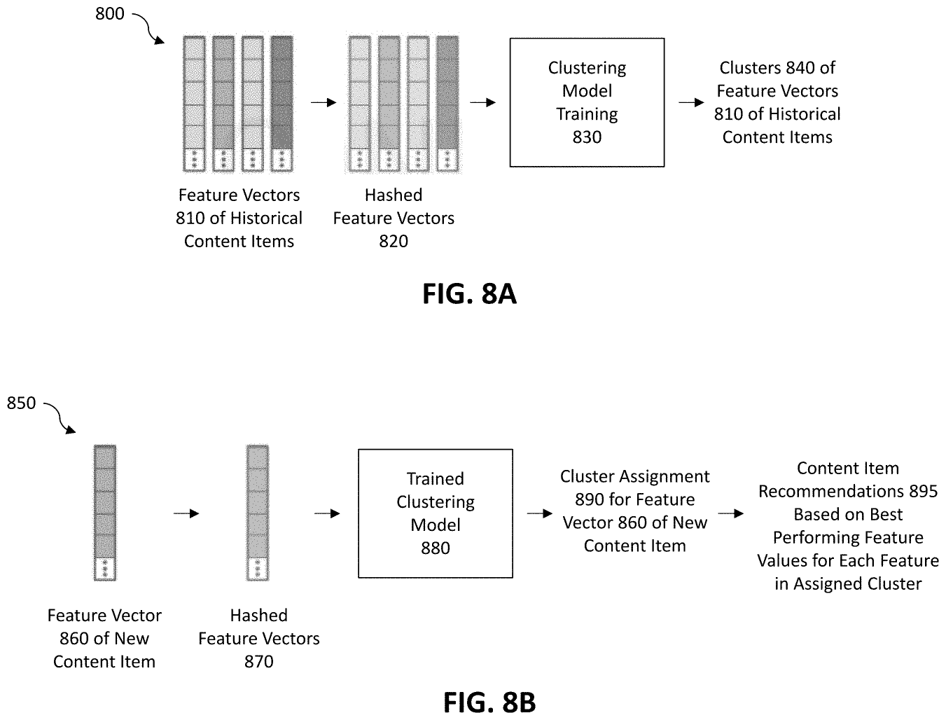

Another (or an alternative) exemplary recommendation method comprises assigning a given content item to at least one cluster of a plurality of clusters of content items. The given content item then inherits at least one recommendation based on one or more properties of the at least one cluster (e.g., the best performing feature value(s) in the at least one cluster based on a benchmark feature value or a significance of a feature value among different feature values in a cluster). For example, the clusters may be determined using a feature-grouped analysis process that groups content items based on, for example, their respective benchmark group (or a different significant feature) or a hashing algorithm that applies a hash function to the feature values vector 318 (e.g., representations of the content items) to group them into clusters, as discussed further below in conjunction with FIGS. 8A and 8B. For the hash-based clustering technique, the similarity between content items is employed to group the content items into clusters and then the best feature values associated with the cluster that a given content item is assigned to can be recommended for addition to the given content item, if not already present in the content item.

In one implementation of the feature-grouped analysis process, the average KPI (key performance indicator) is computed for each feature (e.g., object: dog) for each benchmark, using content items in that benchmark. The average KPI for object:dog in a “wedding” group will be different from the average KPI for object:dog in a “graduation” group. For each content item, the benchmark is identified that the content item belongs in. Then, for each feature value that has a non-zero average KPI in the group comprising the content item, if the new feature value is better than the current feature value in the content item, then a recommendation is made to apply the changed feature value.

In some embodiments, a given feature category can only take on a single value (e.g., a feature “product is present” can take on the feature values: “yes,” “no,” or “no product”). If a content item has the feature that should be changed according to the recommendation, then the value of the feature is recommended to be changed to one of the other feature values for the product category (for example, if “no” is the feature value to be changed, the recommendation would comprise changing a feature value of “no” to a feature value of “yes” and/or changing a feature value of “no” to a feature value of “no product”). Likewise, if a content item does not have the feature that should be changed according to the recommendation, then recommend changing the existing feature value for that category to the feature value associated with the recommendation. (e.g., if “no” is the feature value to be changed, the recommendation would comprise changing a feature value of “yes” to a feature value of “no”).

In some embodiments, a given feature category may take on multiple feature values (such as the feature “background colors” of a content item can take on multiple color values). If a content item has the feature value that should be changed according to the recommendation, then a recommendation can be suggested to remove the feature value. For example, if “yellow” is the feature value to be changed according to the recommendation, then the recommendation may be to remove “yellow.” Likewise, if a content item does not have the feature value that should be changed according to the recommendation, then the recommendation may be to add the feature value. For example, if “yellow” is the feature value to be changed according to the recommendation, then the recommendation may be to add “yellow.”

In some embodiments, the trained engagement prediction model 320 may be implemented using a regression-based machine learning model and/or a classification-based machine learning model. For example, for a classification-based machine learning model, one or more content item-level thresholds may be employed to assign an influence score to one or more feature values associated with a given content item using a classification into one or more bins (based on a comparison of the influence scores to the corresponding thresholds). For an implementation employing a “good” and “bad” classification or a “satisfactory” and “unsatisfactory” classification for a content item, the associated content item-level threshold employed by the classifier may be obtained, for example, by clustering one or more content item-level performance indicators associated with the content items (e.g., KPIs) and selecting a centroid of a middle cluster as the content item-level threshold. Representative KPIs indicative of a performance of a content item may comprise a cost per action, a click through rate, a cost per video view, a cost per lead, and other such metrics.

For an exemplary regression-based machine learning model, a performance of one or more content items can be predicted based on the feature values of the individual content item or the feature values of the multiple content items, respectively. A single asset regressor model can be used for a single asset (e.g., a single content item) and a multi-asset regressor model can be employed to predict a KPI for multiple content items.

FIG. 4 is a block diagram illustrating an exemplary feature selection system 400 that selects one or more features to be processed by the trained engagement prediction model 320 of FIG. 3, according to one illustrative embodiment of the disclosure. In the example of FIG. 4, once the features of interest are selected by the feature selection system 400, the feature extractor 315 of FIG. 3 can generate a feature values vector 318 comprising a feature value for each feature selected by the feature selection system 400. Thus, the feature selection module 114 of FIG. 1 and/or the feature selector 310 of FIG. 3 may be implemented, at least in part, using at least portions of the feature selection system 400.

In some embodiments, the feature selection system 400 selects features using an artificial intelligence technique that performs a sub-image analysis (e.g., a per-pixel analysis) on one or more historical content items. The sub-image analysis may comprise evaluating an area of influence for at least one region of the historical content items when a feature value of at least one feature associated with the at least one region is changed.

In the example of FIG. 4, the feature selection system 400 comprises a pixel-level engagement prediction model 410, a pixel-level explainability model 450 and a heat map analyzer 460 for feature selection. In some embodiments, the pixel-level engagement prediction model 410 may be implemented as a deep neural network (e.g., trained on a pixel level using computer vision techniques, historical content items 405 (e.g., content items as training data labeled with “good” or “bad” classifications for a supervised learning problem) and an object detection model 414) to generate content item classifications 420 and corresponding probabilities 425 (e.g., classification probabilities) that classify content items as “good” or “bad” with an indicated level of confidence. The labels of “good” or “bad” for each content item may depend in some embodiments on a benchmark KPI applicable to the historical content item 405.

The object detection model 414 may be implemented, at least in part, using the pretrained ResNet-50 convolutional neural network to classify images (or portions thereof) in the historical content items 405 into a number of different object categories (e.g., high-level patterns, shapes, and objects). For example, if a given historical content item 405 comprises a textual promotional bubble the object detection model 414 may identify the text, color, discounts, subtitle presence, and/or hashtag/@ presence associated with the textual promotional bubble.

In the example of FIG. 4, the pixel-level engagement prediction model 410 further comprises a fully connected layer 418 that receives the classifications and detected objects (e.g., high-level patterns, shapes, objects and processes) from the object detection model 414 and associates such high-level objects to learn to make decisions on whether a given content item should have a content item classification 420 of good or bad.

In one or more embodiments, the pixel-level explainability model 450 uses the pixel-level engagement prediction model 410 to generate a heat map 458 indicating areas of a given historical content item 405 that are positive or negative. The term “heat map” as used herein shall be broadly construed to encompass any visualization (e.g., binary or continuous) of classifications and/or influence scores of content items (or portions thereof). For example, green patches in the heat map 458 may indicate a “good” classification (e.g., a positive influence on a predicted outcome) for a given region and red patches in the heat map 458 may indicate a “bad” classification (e.g., a negative influence on a predicted outcome) for a given region of the respective historical content item 405. For example, a green patch near a face in a given historical content item 405 and in close proximity to a message that indicates a product discount within the given historical content item 405 may generate a recommendation of face presence and discount presence as feature values to include within a content item.

The pixel-level explainability model 450 may evaluate the content item classifications 420 and corresponding classification probabilities 425 from the pixel-level engagement prediction model 410 for different perturbed feature vectors 454 (e.g., a perturbed version of the feature vector associated with each evaluated historical content item 405) and then generate a heat map 458 for each evaluated historical content item 405. The perturbed feature vectors 454 change one or more feature values associated with each evaluated historical content item 405, for example, at a pixel level. The pixel-level explainability model 450 may employ one or more explainability techniques (such as SHapley Additive exPlanations (SHAP), Anchor, LIME, and/or GradCam explainers) to visualize the pixels that positively influenced a performance of each evaluated historical content item 405. The result of processing the content item classifications 420 and corresponding classification probabilities 425 by the pixel-level explainability model 450 for the perturbed feature vectors 454 is a single heat map 458 for each evaluated historical content item 405. The heat map 458 provides pixel-level contributions of whether the corresponding image region is contributing in a positive or negative manner to the content item classification 420.

The positive and negative portions of the heat map 458 are evaluated (e.g., using manual and/or computer vision techniques) by the heat map analyzer 460 to identify selected features 470 that contributed to the content item classification 420 of the corresponding historical content item 405 being good or bad, respectively.

FIG. 5 is a block diagram illustrating an exemplary feature extraction system 500 that extracts one or more features from content items, according to an illustrative embodiment. In the example of FIG. 5, the feature extraction system 500 comprises one or more feature extraction models 520, an automated labeling engine 525 and a manual labeling engine 530. The feature extraction module 118 of FIG. 1 and/or the feature extractor 315 of FIG. 3 may be implemented, at least in part, using at least portions of the feature extraction system 500. The feature extraction system 500 processes new content items 510 and generates a feature values vector 540 comprising a feature value for each feature that was selected by the feature selector 310 of FIG. 3.

The one or more feature extraction models 520 may comprise custom feature extraction models and/or commercially available feature extraction models. For example, the commercially available feature extraction models may comprise one or more of an AlexNet model, a ResNet model, an Inception model and/or a VGG model from PyTorch and the custom feature extraction models may comprise one or more of a face presence model, a production detection model, a model angle machine learning model, a composition model, a phone-in-pocket model, a pattern detection model and a part-of-product model. One or more of the feature extraction models 520 may be pretrained using a manual extraction process for a sample of content items.

A new content item 510 is applied to the feature extraction model(s) 520. The feature extraction model(s) 520 may employ machine learning techniques to automatically extract a feature value from the new content item 510 for each selected feature and populates the feature values vector 540 with the extracted feature values (e.g., for processing by the content item modification recommendation engines 325 of FIG. 3). In some embodiments, a new feature extraction model 520 can be trained using one or more existing feature extraction models 520 since these existing feature extraction models 520 are pretrained on more relevant data. Among other benefits, such leveraging of existing feature extraction models 520 often results in more accurate feature extraction models 520 and/or a quicker generation of such feature extraction models 520.

In addition, the extracted feature values are processed as preliminary feature labels 522 by an automated labeling engine 525 that provides the extracted feature values to a manual labeling engine 530, where a manual review of the extracted feature values is performed, where one or more of the preliminary feature labels 522 may be changed to form updated feature labels 535.

In this manner, a number of different labeling methods may be employed to extract at least some of the different feature values, such as a manual process by the manual labeling engine 530 an automated process by the automated labeling engine 525 or a combination of the foregoing techniques to achieve a semi-automatic feature extraction.

In some embodiments, one or more of the feature extraction model(s) 520 may be updated using at least some of the changed feature values in the updated feature labels 535 to improve the feature extraction over time. In this manner, as more feature tags are manually cleaned and/or labeled by humans, the feature extraction models will become more accurate (e.g., as the pool of labeled data increases as features are extracted and cleaned from different content items 510).

FIG. 6 is a block diagram illustrating an exemplary feature-level influence scoring system 600 that generates one or more influence scores for one or more feature vectors 605 associated with one or more corresponding new content items, according to at least one embodiment of the disclosure. In the example of FIG. 6, the feature-level influence scoring system 600 processes a feature vector 605 associated with a corresponding new content item that comprises the feature values extracted from a new content item to generate influence scores 670 for each feature value in the feature vector 605.

In at least some embodiments, the feature-level influence scoring system 600 comprises a feature-level explainability model 650, a trained feature-level engagement prediction model 610 and an influence score transformation engine 660. The feature-level explainability model 650 may provide one or more perturbed feature vector(s) 654 (e.g., a perturbed version of the feature vector 605 for the new content item) to the trained feature-level engagement prediction model 610 to obtain content item classifications 620 and corresponding probabilities 625 (e.g., classification probabilities) for each different perturbed feature vector 654 of the feature vector 605 from the trained feature-level engagement prediction model 610. The perturbed feature vector(s) 654 change one or more feature values in each evaluated feature vector 605.

The feature-level explainability model 650 evaluates the content item classifications 620 and corresponding classification probabilities 625 from the trained feature-level engagement prediction model 610 for each different perturbed feature vector 654 (e.g., each perturbed version of the feature vector 605 of the new content item) and generates an intermediate influence score 655 for each feature value in a given feature vector 605.

The feature-level explainability model 650 employs at least one explainability technique, such as a SHapley Additive exPlanations (SHAP) explainer, to generate the intermediate influence score 655 for each feature value in the feature vector 605 for the new content item. In such an implementation that employs a SHAP explainer model, the SHAP explainer model generates SHAP values as the intermediate influence scores 655. The intermediate influence score 655 for each feature value indicates whether the respective feature value is contributing in a positive or negative manner to the content item classification 620 for the new content item. The intermediate influence scores 655 may exist in a continuous range of negative infinity to positive infinity (where a negative intermediate influence score 655 for a feature value indicates that when the feature value is included in the content item, the feature value drives the predicted performance to be a lower number, and a positive intermediate influence score 655 for a feature values indicates that when a feature value is included in the content item, the feature value drives the predicted engagement performance to be a higher number).

The trained feature-level engagement prediction model 610 may employ, for example, an XGBoost decision-tree-based ensemble Machine Learning algorithm to generate the content item classifications 620 and corresponding classification probabilities 625 for each different perturbed feature vector 654 of the new content item.

In the example of FIG. 6, the intermediate influence scores 655 are transformed by an influence score transformation engine 660 that transforms raw intermediate influence scores 655 into a scaled range, such as integers ranging from values of −5 to +5, to provide an influence score 670 for each feature value in the feature vector 605. Among other benefits, the transformed influence scores in the scaled range enable the extrapolation of interpretable insights from the transformed influence score assigned to each feature value of a content item. In at least one embodiment, the influence score transformation may be performed as follows:

obtain the intermediate influence scores 655 for all feature values;

separate the intermediate influence scores 655 for all feature values into a first group having positive intermediate influence scores 655 and a second group having negative intermediate influence scores 655 (and ignore the intermediate influence scores 655 having zero influence);

compute influence scores for a particular positive feature value in the first group based on their percentile when compared to other positive features (in magnitude), using the buckets defined below; and

compute influence scores for a particular negative feature value in the second group based on their percentile when compared to other negative features (in magnitude), using the buckets defined below.

One exemplary percentile buckets-to-influence score mapping is shown below:

0-20%: influence score of 1 (or −1 for negative SHAP values);

20-40%: influence score of 2 (or −2 for negative SHAP values);

40-60%: influence score of 3 (or −3 for negative SHAP values);

60-80%: influence score of 4 (or −4 for negative SHAP values); and

80-100%: influence score of 5 (or −5 for negative SHAP values).

Consider an example of a transformed influence score based on the buckets defined above, where a −5 transformed influence score can represent a feature having a negative impact on the predicted engagement of a content item. Furthermore, the magnitude of such negative impact is significant being that −5 is the most negative score along the scoring scale. The feature-level influence scoring system 600 can map the influence score to a corresponding percentile of negative or positive influences. For example, a score mapping can correlate an influence score of 1 or −1 to a 0% to 20% positive or negative influence, respectively, on the content item. An influence score of 5 or −5 can correlate to an 80% to 100% positive or negative influence, respectively, on the content item predicted engagement.

FIG. 7A is a graph 700 illustrating a number of exemplary influence scores 710 assigned to particular feature values of a given content item using the feature-level influence scoring system 600 of FIG. 6, according to one embodiment of the disclosure.

FIG. 7B illustrates a number of exemplary content item modification recommendations 750 for the given content item based on the exemplary influence scores 710 assigned to particular feature values of the given content item in the example of FIG. 7A, according to an embodiment. Generally, the content item modification recommendations 750 are generated by selecting a given feature of the given content item having a feature value with a negative influence score and modifying the feature value of the given feature to a new feature value having an improved influence score, such as a positive influence score (for example, the suggested transformations can be based on those changes that most dramatically change negative influence scores associated with initial feature values of the content item to positive impacting values).

In the example of FIG. 7A, the associated content item has two feature values (“no logo” and “direct front”) with negative influence scores. The content item modification recommendations 750 comprise suggesting (i) changing the model angle of a model in the content item from a direct front angle orientation to an angled front orientation, and (ii) adding a logo to the content item (that previously did not have a logo, as indicated by the feature value of “no logo”).

FIG. 8A illustrates an exemplary automated clustering process 800 that applies a hash function to feature vectors 810 of historical content items to group the feature vectors 810 into clusters, according to at least one embodiment of the disclosure. Generally, the automated clustering process 800 evaluates the similarity between the feature vectors 810 of the historical content items to group the feature vectors 810 (and corresponding historical content items) into clusters 840 of the feature vectors 810 of the historical content items. The clustering of the historical content items by the automated clustering process 800 provides a mechanism for generating recommendations for new content items, as discussed further below in conjunction with FIG. 8B (for example, the best feature values associated with a cluster that a given content item is assigned to can be recommended for addition to the given content item, if the best feature values are not already present in the content item).

In the example of FIG. 8A, a hash function is applied to the feature vectors 810 of the historical content items to obtain hashed feature vectors 820. The hashed feature vectors 820 are used to train a clustering model, such as a K-Means clustering model, at stage 830 that learns to form clusters 840 of the feature vectors 810 of the historical content items, where similar feature vectors 810 are assigned to the same cluster. In some embodiments, a KPI average is determined for each feature value in a given cluster.

FIG. 8B is a block diagram illustrating an exemplary cluster-based feature-level recommendation engine 850 that generates one or more content item recommendations 895 for a new content item, according to at least one embodiment of the disclosure. In the example of FIG. 8B, a hash function is applied to a feature vector 860 for a new content item to obtain a hashed feature vector 870. The hashed feature vector 870 is used by the trained clustering model 880 (trained using the techniques of FIG. 8A) to generate a cluster assignment 890 for the feature vector 860 of the new content item (e.g., assign the new content item to one of the clusters 840 of FIG. 8A). One or more content item recommendations 895 are generated for the new content item based on, for example, one or more best performing feature values for each feature in the assigned cluster. For example, a content item recommendation 895 may be based on a determination that the new content item is assigned to a cluster where at least some of the best performing feature values of the assigned cluster are not already present in the new content item. The recommendation may comprise adding one or more of the best feature values to the new content item (where the best feature values are determined using the KPI averages determined for each feature value in the assigned cluster).

FIG. 9 illustrates an exemplary ranking system 900 that ranks one or more per model content item recommendations 920 generated for a new content item, according to at least one embodiment of the disclosure. The content item recommendations 920 are generated by one or more content item modification recommendation engines 915-1 through 915-N. As discussed above in conjunction with FIG. 3, for example, the content item modification recommendation engines 915 evaluate an influence score for each feature value and generate one or more recommendations for a given new content item. In some embodiments, content item modification recommendation engines 915-1 through 915-N employ different recommendation methods to generate the content item recommendations 920, such as the recommendation methods discussed above in conjunction with FIGS. 3, 7B and 8B.

In the example of FIG. 9, a recommendation aggregator 930 applies one or more aggregation techniques, such as a consensus technique, to the content item recommendations 920 to generate a set of ranked content item modification recommendations 950. In an implementation of the recommendation aggregator 930 that employs a consensus technique, for example, if a given recommendation of the content item recommendations 920 is generated by more than one content item modification recommendation engine 915 the given recommendation would qualify for consensus. Generally, a consensus among the various recommendation generation methods may provide a more impactful recommendation and reduce conflicts.

In some embodiments, the recommendation aggregator 930 may generate updated influence scores using one of the following methods (where “#rec-gen methods” indicates the number of recommendation generation methods that a given recommendation appears in):

Multiplicity factor method:

updated_influence_score=#rec-gen methods*maximum influence score;

Median of influence scores method:

updated_influence_score=median (influence_scores)

Maximum of all influence scores method:

updated_influence_score=max(impact_scores)

In this manner, an updated influence score is higher, for example, if multiple recommendation generation methods have a higher influence score for a given recommendation. In addition, a predicted improvement in performance increases when multiple recommendations are performed in tandem.

As used herein, in at least some embodiments, a feature describes a content item based on one or more characteristics of the content item (e.g., an advertisement). In some embodiments, exemplary features include product composition, backdrop style, text keywords, or other such data that describes a content item, such as an advertisement or other type of marketing material. A feature value is a permissible value of a given feature. For example, for the backdrop style feature, some feature values may include: “wood,” “curtain,” or “solid white.” An intermediate feature, in at least some embodiments, is a feature that is extracted or derived from a content item, is possibly manually cleaned or modified, and used by another feature. One example of an intermediate feature is a “product detection” feature that extracts bounding boxes of products. The “product detection” feature is manually cleaned or modified and is used by a derived feature of “number of products.”

Thus, a derived feature is a feature that uses an intermediate feature to obtain feature values. One example of a derived feature is the “number of products” feature that uses the intermediate feature “product detection” (which extracts bounding boxes of products, as noted above). In some embodiments, the employed techniques for defining feature extraction models provide significant extensibility and flexibility to efficiently create new features, and to create complex features using manual and/or automatic feature extraction techniques, as discussed above.

A KPI is a metric that measures a performance of a content item. Representative KPIs include cost per action, click through rate, cost per video view, cost per buy lead, cost per lead, cost per add to cart, and cost per on-Facebook lead. In some embodiments, the optimization process may be performed for one or more KPIs, depending on the KPI that the content item would be based on.

In some embodiments, the disclosed feature-level recommendation generation techniques improve the performance of content items. One or more embodiments of the disclosure provide methods, systems and processor-readable storage media for generating feature-level recommendations for content items. The embodiments described herein are illustrative of the disclosure, and other embodiments can be configured using the disclosed techniques for generating feature-level recommendations for content items.

The disclosed feature-level recommendation generation techniques can be implemented using one or more programs stored in memory and executed by a processor of a processing device or platform. One or more of the processing modules and other components described herein may each be executed on a computing device or another element of a processing platform.

FIG. 10 illustrates an exemplary processing device 1000 that may implement one or more portions of at least one embodiment of the disclosure. The processing device 1000 in the example of FIG. 10 comprises a processor 1010, a memory 1020 and a network interface 1030. The processor 1010 may comprise a microprocessor, a microcontroller, an ASIC, an FPGA and/or other processing circuitry. The memory 1020 is one example of a processor-readable storage media that stores executable code of one or more software programs. The network interface circuitry 1030 is used to interface the processing device with one or more networks, such as the communication network 150 of FIG. 1, and other system components, and may comprise one or more transceivers.

One or more embodiments include articles of manufacture, such as computer or processor-readable storage media. Examples of an article of manufacture include, without limitation, a storage device such as a storage disk, a storage array or an integrated circuit comprising memory, as well as a wide variety of other types of computer program products. The term “article of manufacture” shall not include transitory, propagating signals.

Cloud infrastructure comprising virtual machines, containers and/or other virtualized infrastructure and/or cloud-based services may be used to implement at least portions of the disclosed techniques for feature-level recommendation generation.

FIG. 11 illustrates an exemplary cloud-based processing platform 1100 in which cloud-based infrastructure and/or services can be used to generate feature-level recommendations for content items, according to an exemplary embodiment. The cloud-based processing platform 1100 comprises a combination of physical and/or virtual processing resources that may be utilized to implement at least a portion of the disclosed techniques for feature-level recommendation. The cloud-based processing platform 1100 comprises one or more virtual machines and/or containers 1120 implemented using a virtualization framework 1130. The virtualization framework 1130 executes on a physical framework 1140, and illustratively comprises one or more hypervisors and/or operating system-level virtualization framework.

The cloud-based processing platform 1100 further comprises one or more applications 1110 running on respective ones of the virtual machines and/or containers 1120 under the control of the virtualization framework 1130. The virtual machines and/or containers 1120 may comprise one or more virtual machines, one or more containers, or one or more containers running in one or more virtual machines.

The virtual machines and/or containers 1120 may comprise one or more virtual machines implemented using virtualization framework 1130 that comprises one or more hypervisors. In this manner, feature-level recommendation generation functionality can be provided for one or more processes running on a given virtual machine.

The virtual machines and/or containers 1120 may comprise one or more containers implemented using virtualization framework 1130 that provides operating system-level virtualization functionality, for example, that supports Docker containers. In this manner, feature-level recommendation generation functionality can be provided for one or more processes running on one or more of the containers.

Multiple elements of an information processing system may be collectively implemented on a common processing platform of the type shown in FIGS. 10 and/or 11, or each such element may be implemented on a separate processing platform. It is noted that other arrangements of computers, host device, storage devices and/or other components may be employed in other embodiments.

Thus, the embodiments described herein are presented for illustration and a number of variations and other alternative embodiments may be used, as would be apparent to a person of ordinary skill in the art. In addition, the particular configurations of system and device elements, as well as associated processing operations, shown in the presented figures may be modified in other embodiments. Numerous other embodiments within the scope of the following claims would be apparent to those of ordinary skill in the art.

What is claimed is:

1. A method, comprising:
obtaining a plurality of feature values related to a content item, wherein each given one of the plurality of feature values corresponds to a respective one of a plurality of features;
applying the plurality of feature values to at least one trained engagement prediction model that generates an influence score for each of the plurality of feature values, wherein the influence score for each of the plurality of feature values indicates an influence of each respective feature value on at least one performance indicator associated with the content item;
generating one or more recommendations for improving the at least one performance indicator associated with the content item using the influence score for each of the plurality of feature values; and
initiating at least one modification of the content item using at least one of the one or more recommendations;
wherein the method is performed by at least one processing device comprising a processor coupled to a memory.

2. The method of claim 1, wherein one or more of the plurality of corresponding features are selected using an artificial intelligence technique that performs a sub-image analysis on at least one historical content item, and wherein the sub-image analysis comprises evaluating an area of influence for at least one region of the at least one historical content item when a feature value of at least one feature associated with the at least one region is changed.

3. The method of claim 1, wherein one or more of the plurality of feature values are determined using an automated feature extraction process that employs at least one machine learning model and wherein at least some of the automatically determined feature values are modified using a manual process.

4. The method of claim 3, further comprising updating the at least one machine learning model based at least in part on at least some of the automatically determined feature values that are modified using the manual process.

5. The method of claim 1, wherein the at least one trained engagement prediction model comprises a plurality of trained engagement prediction models and wherein a given one of the plurality of trained engagement prediction models is selected for the content item based on a performance of each of the plurality of trained engagement prediction models.

6. The method of claim 1, wherein the at least one trained engagement prediction model determines a SHAP value for each of the plurality of feature values that indicates an impact of a given feature on a performance of the content item.

7. The method of claim 1, wherein the generating the one or more recommendations for improving the at least one performance indicator associated with the content item further comprises selecting a given corresponding feature having a feature value with an influence score in a predefined range and modifying the feature value of the given corresponding feature to a new value having an improved influence score in a different predefined range.

8. The method of claim 1, wherein a given corresponding feature has multiple different feature values and wherein at least one of the multiple different feature values is selected for the given corresponding feature by ranking at least some of the multiple different feature values using a predicted performance value for each of the multiple different feature values.

9. The method of claim 1, wherein the generating the one or more recommendations for improving the at least one performance indicator associated with the content item further comprises assigning a given content item to at least one cluster of a plurality of clusters of content items and wherein the given content item inherits at least one recommendation based at least in part on one or more properties of the at least one cluster.

10. The method of claim 9, wherein at least one threshold is determined for the at least one performance indicator by evaluating an average performance indicator value for each of the plurality of feature values for each of a plurality of clusters of content items.

11. The method of claim 10, wherein the generating the one or more recommendations for improving the at least one performance indicator associated with the content item further comprises selecting a new feature value for a given feature if a change of a performance indicator for the new feature value relative to the performance indicator for a current feature value for the given feature satisfies one or more performance criteria.

12. The method of claim 1, further comprising assigning the influence score of at least a first one of a plurality of feature values associated with a given feature based at least in part on at least one influence score assigned to at least one additional feature value that is correlated with the first feature value.

13. The method of claim 1, wherein the one or more recommendations for improving the at least one performance indicator associated with the content item comprise a plurality of recommendations and wherein the plurality of recommendations are aggregated based at least in part on a consensus between a plurality of different recommendation methods that generated the plurality of recommendations.

14. The method of claim 13, further comprising updating one or more of a ranking and a weight associated with the plurality of different recommendation methods based at least in part on implicit feedback derived from one or more user actions with respect to at least one of the one or more recommendations.

15. The method of claim 13, further comprising modifying a weight associated with one or more of the plurality of features based at least in part on a performance of at least one of the one or more recommendations.

16. The method of claim 1, wherein the content item comprises at least one component of a larger content item.

17. An apparatus comprising:
at least one processing device comprising a processor coupled to a memory;
the at least one processing device being configured to implement the following steps:
obtaining a plurality of feature values related to a content item, wherein each given one of the plurality of feature values corresponds to a respective one of a plurality of features;
applying the plurality of feature values to at least one trained engagement prediction model that generates an influence score for each of the plurality of feature values, wherein the influence score for each of the plurality of feature values indicates an influence of each respective feature value on at least one performance indicator associated with the content item;
generating one or more recommendations for improving the at least one performance indicator associated with the content item using the influence score for each of the plurality of feature values; and
initiating at least one modification of the content item using at least one of the one or more recommendations.

18. A non-transitory processor-readable storage medium having stored therein program code of one or more software programs, wherein the program code when executed by at least one processing device causes the at least one processing device to perform the following steps:
obtaining a plurality of feature values related to a content item, wherein each given one of the plurality of feature values corresponds to a respective one of a plurality of features;
applying the plurality of feature values to at least one trained engagement prediction model that generates an influence score for each of the plurality of feature values, wherein the influence score for each of the plurality of feature values indicates an influence of each respective feature value on at least one performance indicator associated with the content item;
generating one or more recommendations for improving the at least one performance indicator associated with the content item using the influence score for each of the plurality of feature values; and
initiating at least one modification of the content item using at least one of the one or more recommendations.

19. The non-transitory processor-readable storage medium of claim 18, wherein one or more of the plurality of corresponding features are selected using an artificial intelligence technique that performs a sub-image analysis on at least one historical content item, and wherein the sub-image analysis comprises evaluating an area of influence for at least one region of the at least one historical content item when a feature value of at least one feature associated with the at least one region is changed.

20. The non-transitory processor-readable storage medium of claim 18, wherein one or more of the plurality of feature values are determined using an automated feature extraction process that employs at least one machine learning model and wherein at least some of the automatically determined feature values are modified using a manual process, and further comprising updating the at least one machine learning model based at least in part on at least some of the automatically determined feature values that are modified using the manual process.

21. The non-transitory processor-readable storage medium of claim 18, wherein the at least one trained engagement prediction model comprises a plurality of trained engagement prediction models and wherein a given one of the plurality of trained engagement prediction models is selected for the content item based on a performance of each of the plurality of trained engagement prediction models.

22. The non-transitory processor-readable storage medium of claim 18, wherein the generating the one or more recommendations for improving the at least one performance indicator associated with the content item further comprises selecting a given corresponding feature having a feature value with an influence score in a predefined range and modifying the feature value of the given corresponding feature to a new value having an improved influence score in a different predefined range.

23. The non-transitory processor-readable storage medium of claim 18, wherein the generating the one or more recommendations for improving the at least one performance indicator associated with the content item further comprises assigning a given content item to at least one cluster of a plurality of clusters of content items and wherein the given content item inherits at least one recommendation based at least in part on one or more properties of the at least one cluster.

24. The non-transitory processor-readable storage medium of claim 23, wherein the generating the one or more recommendations for improving the at least one performance indicator associated with the content item further comprises selecting a new feature value for a given feature if a change of a performance indicator for the new feature value relative to the performance indicator for a current feature value for the given feature satisfies one or more performance criteria.

25. The non-transitory processor-readable storage medium of claim 18, wherein the one or more recommendations for improving the at least one performance indicator associated with the content item comprise a plurality of recommendations and wherein the plurality of recommendations are aggregated based at least in part on a consensus between a plurality of different recommendation methods that generated the plurality of recommendations.
